(19) United States
(12) Patent Application Publication
(10) Pub. No.: US 2021/0365804 A1
(43) Pub. Date: Nov. 25, 2021

(54) DYNAMIC AI MODEL TRANSFER RECONFIGURATION TO MINIMIZE PERFORMANCE, ACCURACY AND LATENCY DISRUPTIONS

(71) Applicant: Intel Corporation, Santa Clara, CA (US)

(72) Inventors: Yamini Nimmagadda, Portland, OR (US); Akhila Vidiyala, Beaverton, OR (US); Suryaprakash Shanmugam, Bengaluru (IN)

(21) Appl. No.: 17/395,056

(22) Filed: Aug. 5, 2021

(30) Foreign Application Priority Data
Jun. 11, 2021 (IN) 202141026106

(51) Int. Cl. G06N 5/02

(52) U.S. Cl. CPC G06N 5/027

(57) ABSTRACT

Systems, apparatuses and methods may provide for technology that detects a transfer condition with respect to an artificial intelligence (AI) workload that is active on a source edge node, conducts intra-node tuning on a destination edge node in response to the transfer condition, and moves the AI workload to the destination edge node after the intra-node tuning is complete.

### CROSS-REFERENCE TO RELATED APPLICATIONS

The present application claims the benefit of priority to Indian Provisional Patent Application No. 202141026106, filed Jun. 11, 2021.

### TECHNICAL FIELD

This disclosure relates generally to artificial intelligence (AI). More particularly, this disclosure relates to dynamic AI model transfer reconfigurations to minimize performance, accuracy and latency disruptions.

### BACKGROUND OF THE DISCLOSURE

In cluster environments, usually artificial intelligence (AI) workloads/models may wait in a pipeline to be served. When multiple models arrive at the same time and request the same resource, the models may typically be served on first come first serve basis. Accordingly, there may be delays and a relatively important model execution might be waiting for a longer time than appropriate.

For example, KUBEFLOW pipelines may be helpful when building large scale machine learning models and testing the model accuracy. For KUBEFLOW pipelines, however, the models are served sequentially on first come first serve basis, which may be slower and less efficient.

Additionally, the NVDIA TRITON Inference Server may serve models on CUDA enabled graphics processing units (GPUs). The TRITON inference server does not dynamically reconfigure the deployment while the workloads are executing.

Moreover, KF SERVING solutions may serve models of multiple frameworks with a single API (application programming interface). KF SERVING does not optimize the model execution, however, and does not take into account the priority of the model for better performance. This solution merely provides a standard API for the user to deploy the model in multiple frameworks.

### BRIEF DESCRIPTION OF THE DRAWINGS

So that the manner in which the features of the present embodiments can be understood in detail, a more particular description of the embodiments may be had by reference to embodiments in the following detailed description, some of which are illustrated in the appended drawings. It is to be noted, however, that the appended drawings illustrate only typical embodiments and are therefore not to be considered limiting of its scope.

FIG. 1 is a block diagram of an example of an AI framework integration system according to an embodiment;

FIG. 2 is a flowchart of an example of a method of operating a performance-enhanced computing system according to an embodiment;

FIG. 3 is an illustration of an example of an execution timeline according to an embodiment;

FIG. 4 is a block diagram of an example of a performance-enhanced computing apparatus according to an embodiment;

FIG. 5 is an illustration of an example of a semiconductor package apparatus according to an embodiment;

FIG. 6 is a block diagram of an example of a processor according to an embodiment; and

FIG. 7 is a block diagram of an example of a multi-processor based computing system according to an embodiment.

### DETAILED DESCRIPTION

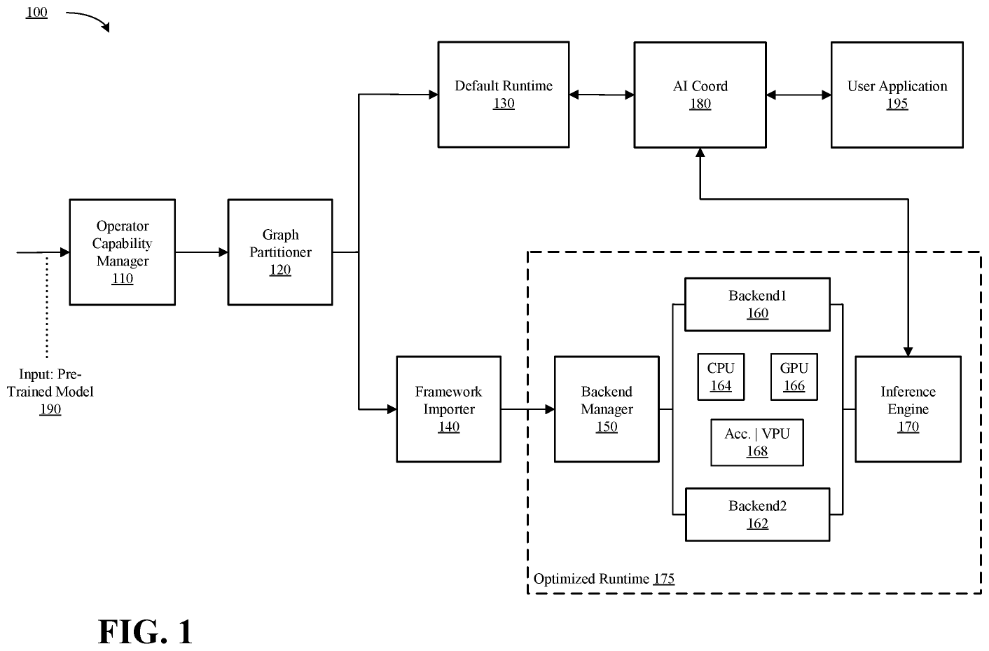

FIG. 1 provides a block diagram illustrating an example of an artificial intelligence (AI) framework integration system 100 according to one or more embodiments, with reference to components and features described herein including but not limited to the figures and associated description. As shown in FIG. 1, the system 100 includes an operator capability manager 110, a graph partitioner 120, a default runtime 130, a framework importer 140, a backend manager 150, a first backend (backend1) 160, a second backend (backend2) 162, hardware execution units including a central processing unit (CPU) 164, a graphics processing unit (GPU) 166, and a hardware accelerator such as a vision processing unit (VPU) 168 (or another type of hardware AI accelerator), an inference engine 170 and an AI coordinator 180. It is understood that a variety of hardware execution units including a plurality of CPUs 164, GPUs 166 and/or VPUs 168 can be employed in the system 100. It is further understood that a variety of backends can be included in the system 100. Together, the backend manager 150, the first backend (backend1) 160, the second backend (backend2) 162, the hardware execution units (including one or more CPUs 164, one or more GPUs 166, and one or more VPUs 168) and the inference engine 170 form an optimized runtime 175.

The system 100 receives as input a pre-trained model 190. The pre-trained model 190 can be developed using an AI framework from a variety of sources, including, for example, TensorFlow, ONNX Runtime, PyTorch, etc. The pre-trained model 190 typically includes information and data regarding the model architecture (i.e., graph), including nodes, operators, weights and biases. Each node in a model graph represents an operation (e.g., mathematical, logical operator etc.) which is evaluated at runtime.

The operator capability manager 110 receives the input pre-trained model 190 and analyzes the operators in the model to determine which operators or nodes are supported, and under what conditions, by the available backend technology and hardware units. The analysis includes evaluating the operators, attributes, data types, and input nodes. The operator capability manager 110 marks the operators or nodes as supported or unsupported.

The graph partitioner 120 takes the pretrained model architecture, as marked by the operator capability manager 110, and partitions (e.g., divides) the model into subgraphs (i.e., groups of operators, or clusters). The subgraphs are allocated into two groups—supported subgraphs and unsupported subgraphs. Supported subgraphs are those subgraphs having operators or nodes that are supported by the available backend technology and hardware units under the conditions present in the model. Unsupported subgraphs are those subgraphs having operators or nodes that are not supported by the available backend technology and hardware units under the conditions present in the model. Supported subgraphs are designated for further processing to be run via the optimized runtime 175. Unsupported subgraphs are designated to be run via the default runtime 130. In some circumstances, the system can be “tuned” to enhance speed and efficiency in execution speed and/or memory usage by re-designating certain supported subgraphs to be executed via the default runtime 130.

The default runtime 130 is the basic runtime package provided for the AI framework corresponding to the input pre-trained model 190. The default runtime 130 executes on basic CPU hardware with no hardware accelerator support. The default runtime 130 typically includes a compiler to compile the unsupported subgraphs into executable code to be run on the basic CPU hardware.

The framework importer 140 receives supported subgraphs from the graph partitioner 120. The subgraphs are typically in a format specific to the framework used to generate the model. The framework importer 140 takes the subgraphs and generates an intermediate representation for these subgraphs, to be interpreted (i.e., read/parsed) by the optimized runtime 175. The intermediate representation produces a structured data set comprising the model architecture, metadata, weights and biases.

The backend manager 150 receives the intermediate representation of the supported model subgraphs and applies optimization techniques to optimize execution of the model using available backends and hardware options. For example, the backend manager 150 can select among available backends, (e.g., the first backend 160 or the second backend 162). In some embodiments, the first backend 160 represents a basic backend that is optimized for a particular group of hardware units. For example, where the optimized runtime 175 utilizes the Open Visual Inference and Neural network Optimization (OpenVINO) runtime technology, the first backend 160 can be the OpenVINO backend. In some embodiments, the second backend 162 can be a backend such as VAD-M, which is optimized for machine vision tasks using a VPU such as the Intel® Myriad X VPU. The selected backend compiles (via a compiler) supported subgraphs into executable code and performs optimization. The backend manager 150 also selects among the available hardware units—the CPU 164, GPU 166 and/or VPU (or AI accelerator) 168. The backend manager 150 also dispatches data to the selected backend and schedules execution (inference) of the optimized model via the inference engine 170.

The inference engine 170 controls execution of the model code on the various hardware units that are employed for the particular model optimization. The inference engine 170 reads the input data and compiled graphs, instantiates inference on the selected hardware, and returns the output of the inference.

The AI coordinator 180 coordinates execution of AI workflow requests from a user application 195. The AI workflow requests are handled between the default runtime 130 (executing code generated from unsupported subgraphs) and the optimized runtime 175 (e.g., executing code generated from supported subgraphs). In one or more embodiments, the AI coordinator 180 is integrated within the default runtime 130. In one or more embodiments, the AI coordinator 180 is integrated within the optimized runtime 175. As will be discussed in greater detail, if a transfer condition is detected with respect to an AI workload that is active on a source node such as, for example, the optimized runtime 175, the system 100 conducts an intra-node tuning on a destination node such as, for example, the default runtime 130, before moving the AI workload from the optimized runtime 175 to the default runtime 130.

Embodiments reduce latency based on the priority of models to be served. If the priority of the incoming model is higher than the model that is being run, the current workload is migrated onto a different resource that gives the next best performance, accuracy and lowest latency among the available resources. The migrated workload is therefore served by the different resource.

In embodiments, when a new model or input stream is added and an existing workload is reconfigured from one edge node (“node” where a device or local network interfaces with the Internet) to another, the existing workload is optimized and tuned for the performance and accuracy close to the original node, while reducing the transfer latency of the workload. This solution minimizes the disruptions in performance, accuracy, and latency while moving an AI model from one node to another node. Embodiments will therefore make processor hardware a natural choice of deployment in edge clusters with dynamic deployments.

In embodiments, a solution is provided for dynamic reconfiguration and transfer of workloads from one node to another, when a new model or new input stream is added. If a workload actively executing on a node (e.g., a “source” node) is to be moved to another node (e.g., a “destination” node), the user may experience the following.
Performance Drop: If the destination node has lower compute capacity than the source node, there may be a performance drop.
Accuracy variation: Variations in accuracy if the destination node supports a different precision than the source node.
Transfer Latency: Temporary disruption in the workload execution (e.g., loss of frames or slower execution) during the workload transfer from the source node to the destination node.

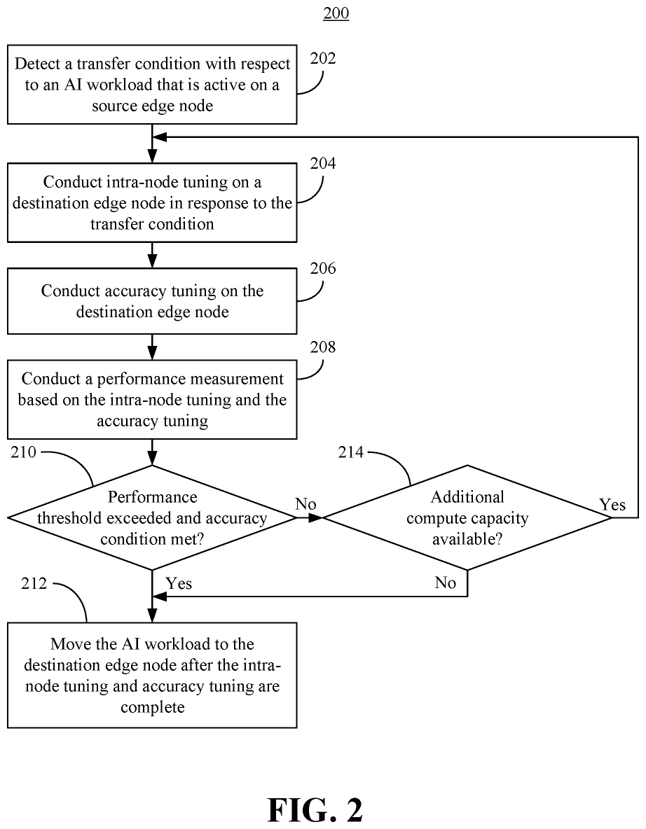

Embodiments co-optimize for performance, accuracy, and latency while moving the workload from one node to another. More particularly, FIG. 2 is a flowchart of an example of a method 200 of operating a performance-enhanced computing apparatus to tune a hardware selection to produce performance and accuracy within chosen thresholds of performance and accuracy, respectively, on a source node. The method 200 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable hardware such as, for example, programmable logic arrays (PLAs), field programmable gate arrays (FPGAs), complex programmable logic devices (CPLDs), in fixed-functionality hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 200 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 202 provides for detecting a transfer condition with respect to an AI workload that is active on a source edge node. The transfer condition might be associated with the introduction of a higher priority AI workload than the workload currently executing on the source edge node. Block 204 conducts an intra-node tuning on a destination edge node in response to the condition. In one example, block 204 involves determining the compute capacity of the destination edge node and allocating one or more host processor (e.g., CPU) cores of the destination edge node to the AI workload if the compute capacity does not exceed a capacity threshold (e.g., floating-point operations per second/FLOPS).

For example, block 204 may check if the compute capacity of the source node is within the chosen threshold of the destination node. If the threshold is not met, the intra-node tuning is conducted by adding more compute units from the same node for running the workload. For example, assuming that the source edge node is a generation 2 (Gen2) VPU (vision processing unit) and the destination edge node is a generation 1 (Gen1) VPU, the Gen2 VPU may have a higher compute capacity compared to the Gen1 VPU. In such a case, intra-node tuning can be performed by adding CPU cores along with the Gen1 VPU to execute the workload and boost the compute capacity.

Block 206 conducts an accuracy tuning on the destination edge node. In an embodiment, the accuracy tuning includes calibrating the AI workload based on the intra-node tuning and a validation dataset. More particularly, the accuracy tuning may use quantization/optimization with a calibration dataset for the model on the destination edge node with the newly tuned compute units. In the above example of a Gen2 to Gen1 transfer, both VPUs may support FP16 (floating point 16). With the addition of CPU cores (FP32/floating point 32) in the intra-node tuning, however, recalibration and quantization of the network for a mixed precision network (FP32 and FP16) may be conducted.

Additionally, block 208 conducts a performance measurement based on the intra-node tuning and the accuracy tuning. If it is determined at block 210 that the performance measurement exceeds a performance threshold (e.g., availability, response time, channel capacity, latency, completion time, service time, bandwidth, throughput, relative efficiency, scalability, performance per watt, compression ratio, instruction path length and/or speed up threshold) and the accuracy tuning satisfies an accuracy condition (e.g., chosen thresholds of the source edge node), block 212 moves the AI workload to the destination edge node after the intra-node tuning and the accuracy tuning are complete. Of particular note is that the intra-node tuning, the accuracy tuning and the performance measurement may be conducted while the AI workload is active on the source edge node.

If it is determined at block 210 that either the performance measurement does not exceed the performance threshold or the accuracy tuning does not satisfy the accuracy condition, illustrated block 214 determines whether there is any additional compute capacity (e.g., available CPU cores) left on the destination edge node. If all CPU cores and hardware compute units of the accelerators are fully utilized, the method 200 proceeds to block 212. Otherwise, the method 200 returns to block 204 and repeats the intra-node tuning (e.g., allocating more compute to the workload). The illustrated method 200 continues tuning in a closed loop manner until the thresholds are met or the compute in the destination node is exhausted.

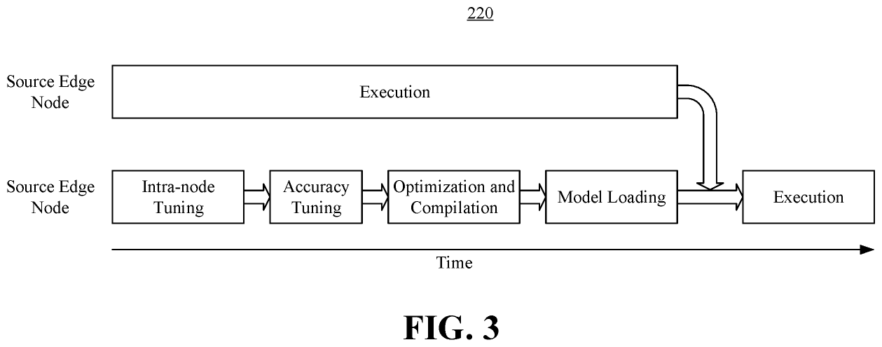

FIG. 3 shows a timeline 220 in which all of the above operations are performed while the workload is still running on the source edge node to minimize the transfer latency of the workload. Only after the model is optimized for performance and accuracy, compiled to the destination accelerator format, and loaded on the accelerator, is the workload execution stopped on the source edge node and the input diverted to the destination node for continuing the execution.

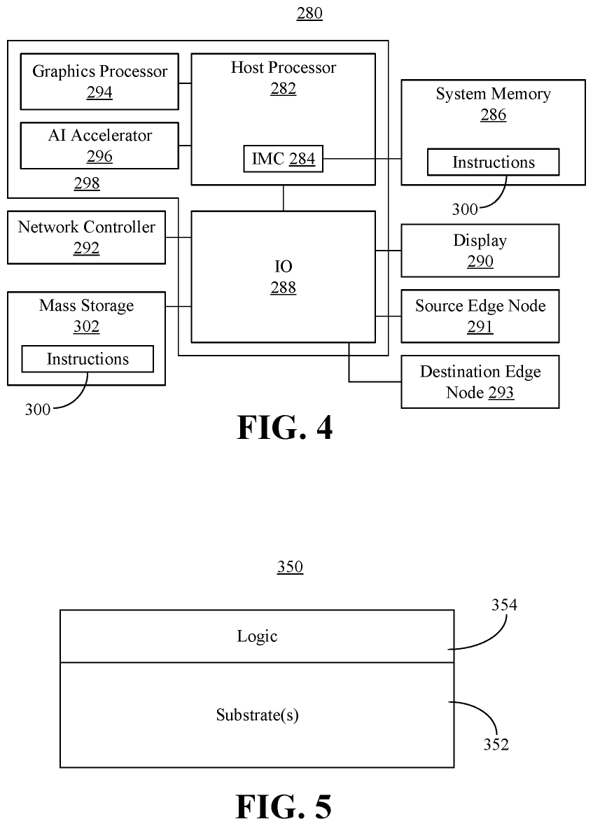

Turning now to FIG. 4, a performance-enhanced computing apparatus 280 is shown. The architecture 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the architecture 280 includes a host processor 282 (e.g., CPU) having an integrated memory controller (IMC) 284 that is coupled to a system memory 286 (e.g., dual inline memory module/DIMM). In an embodiment, an IO module 288 is coupled to the host processor 282. The illustrated IO module 288 communicates with, for example, a display 290 (e.g., touch screen, liquid crystal display/LCD, light emitting diode/LED display), a source edge node 291, a destination edge node 293, and a network controller 292 (e.g., wired and/or wireless). The host processor 282 may be combined with the IO module 288, a graphics processor 294, and an AI accelerator 296 into a system on chip (SoC) 298.

In an embodiment, the host processor 282 executes a set of program instructions 300 retrieved from mass storage 302 and/or the system memory 286 to perform one or more aspects of the method 200 (FIG. 2), already discussed. Thus, execution of the illustrated instructions 300 by the host processor 282 causes the host processor 282 to detect a transfer condition with respect to an AI workload that is active on the source edge node 291, conduct intra-node tuning on the destination edge node 293 in response to the transfer condition, and move the AI workload to the destination edge node 293 after the intra-node tuning is complete. In an embodiment, execution of the instructions 300 by the host processor 282 also causes the host processor 282 to conduct accuracy tuning on the destination edge node and conduct a performance measurement based on the intra-node tuning and the accuracy tuning, wherein the AI workload is moved to the destination edge node if the performance measurement exceeds a performance threshold and the accuracy tuning satisfies an accuracy condition. In one example, the intra-node tuning, the accuracy tuning and the performance measurement are conducted while the AI workload is active on the source edge node. The computing apparatus 280 is therefore considered performance-enhanced at least to the extent that completing the intra-node tuning before moving the AI workload to the destination edge node 293 minimizes disruptions related to performance, accuracy and latency while moving an AI model from one node to another.

FIG. 5 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 200 (FIG. 2), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

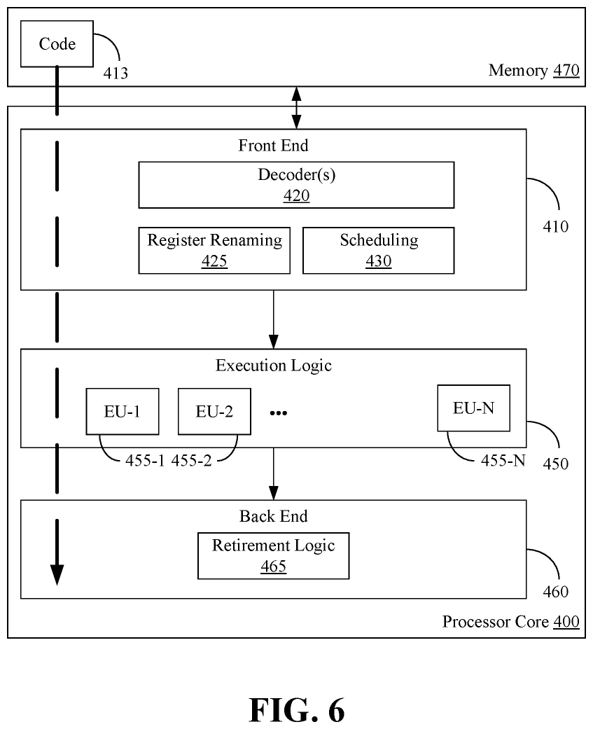

FIG. 6 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 6, a processing element may alternatively include more than one of the processor core 400 illustrated in FIG. 6. The processor core 400 may be a single-threaded core or, for at least one embodiment, the processor core 400 may be multithreaded in that it may include more than one hardware thread context (or “logical processor”) per core.

FIG. 6 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 200 (FIG. 2), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 6, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

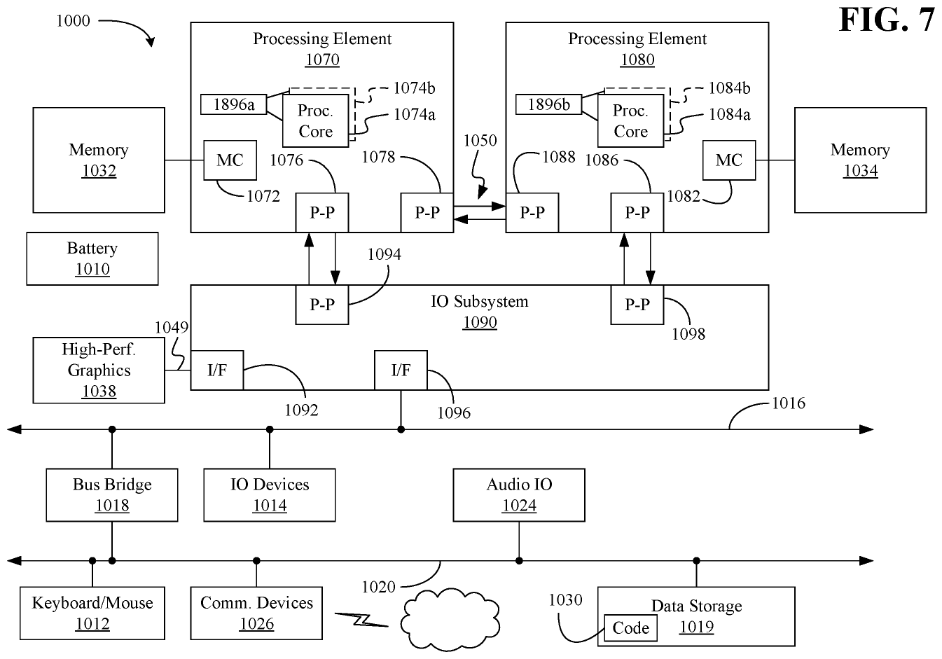

Referring now to FIG. 7, shown is a block diagram of a computing system 1000 embodiment in accordance with an embodiment. Shown in FIG. 7 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 7 may be implemented as a multi-drop bus rather than point-to-point interconnect.

As shown in FIG. 7, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 6.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 7, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 7, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 7, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 200 (FIG. 2), already discussed. Further, an audio I/O 1024 may be coupled to second bus 1020 and a battery 1010 may supply power to the computing system 1000.

Note that other embodiments are contemplated. For example, instead of the point-to-point architecture of FIG. 7, a system may implement a multi-drop bus or another such communication topology. Also, the elements of FIG. 7 may alternatively be partitioned using more or fewer integrated chips than shown in FIG. 7.

### ADDITIONAL NOTES AND EXAMPLES

Example 1 includes a performance-enhanced computing apparatus comprising a source edge node, a destination edge node, a processor, and memory coupled to the processor, the memory comprising a set of instructions, which when executed by the processor, cause the processor to detect a transfer condition with respect to an artificial intelligence (AI) workload that is active on the source edge node, conduct intra-node tuning on the destination edge node in response to the transfer condition, and move the AI workload to the destination edge node after the intra-node tuning is complete.

Example 2 includes the computing apparatus of Example 1, wherein the instructions, when executed, further cause the processor to conduct accuracy tuning on the destination edge node, and conduct a performance measurement based on the intra-node tuning and the accuracy tuning, wherein the AI workload is moved to the destination edge node if the performance measurement exceeds a performance threshold and the accuracy tuning satisfies an accuracy condition.

Example 3 includes the computing apparatus of Example 2, wherein the intra-node tuning, the accuracy tuning and the performance measurement are conducted while the AI workload is active on the source edge node.

Example 4 includes the computing apparatus of Example 2, wherein to conduct the accuracy tuning, the instructions, when executed, cause the processor to calibrate the AI workload based on the intra-node tuning and a validation dataset.

Example 5 includes the computing apparatus of Example 2, wherein the instructions, when executed, further cause the processor to repeat the intra-node tuning if the performance measurement does not exceed the performance threshold or the accuracy tuning does not satisfy the accuracy condition.

Example 6 includes the computing apparatus of any one of Examples 1 to 5, wherein to conduct the intra-node tuning, the instructions, when executed, cause the processor to determine a compute capacity of the destination edge node, and allocate one or more host processor cores of the destination edge node to the AI workload if the compute capacity does not exceed a capacity threshold.

Example 7 includes at least one computer readable storage medium comprising a set of instructions, which when executed by a computing system, cause the computing system to detect a transfer condition with respect to an artificial intelligence (AI) workload that is active on a source edge node, conduct intra-node tuning on a destination edge node in response to the transfer condition, and move the AI workload to the destination edge node after the intra-node tuning is complete.

Example 8 includes the at least one computer readable storage medium of Example 7, wherein the instructions, when executed, further cause the computing system to conduct accuracy tuning on the destination edge node, and conduct a performance measurement based on the intra-node tuning and the accuracy tuning, wherein the AI workload is moved to the destination edge node if the performance measurement exceeds a performance threshold and the accuracy tuning satisfies an accuracy condition.

Example 9 includes the at least one computer readable storage medium of Example 8, wherein the intra-node tuning, the accuracy tuning and the performance measurement are conducted while the AI workload is active on the source edge node.

Example 10 includes the at least one computer readable storage medium of Example 8, wherein to conduct the accuracy tuning, the instructions, when executed, cause the computing system to calibrate the AI workload based on the intra-node tuning and a validation dataset.

Example 11 includes the at least one computer readable storage medium of Example 8, wherein the instructions, when executed, further cause the computing system to repeat the intra-node tuning if the performance measurement does not exceed the performance threshold or the accuracy tuning does not satisfy the accuracy condition.

Example 12 includes the at least one computer readable storage medium of any one of Examples 7 to 11, wherein to conduct the intra-node tuning, the instructions, when executed, cause the computing system to determine a compute capacity of the destination edge node, and allocate one or more host processor cores of the destination edge node to the AI workload if the compute capacity does not exceed a capacity threshold.

Example 13 includes a semiconductor apparatus comprising one or more substrates, and logic coupled to the one or more substrates, wherein the logic is implemented at least partly in one or more of configurable or fixed-functionality hardware, the logic to detect a transfer condition with respect to an artificial intelligence (AI) workload that is active on a source edge node, conduct intra-node tuning on a destination edge node in response to the transfer condition, and move the AI workload to the destination edge node after the intra-node tuning is complete.

Example 14 includes the semiconductor apparatus of Example 13, wherein the logic coupled is to conduct accuracy tuning on the destination edge node, and conduct a performance measurement based on the intra-node tuning and the accuracy tuning, wherein the AI workload is moved to the destination edge node if the performance measurement exceeds a performance threshold and the accuracy tuning satisfies an accuracy condition.

Example 15 includes the semiconductor apparatus of Example 14, wherein the intra-node tuning, the accuracy tuning and the performance measurement are conducted while the AI workload is active on the source edge node.

Example 16 includes the semiconductor apparatus of Example 14, wherein to conduct the accuracy tuning, the logic is to calibrate the AI workload based on the intra-node tuning and a validation dataset.

Example 17 includes the semiconductor apparatus of Example 14, wherein the logic is to repeat the intra-node tuning if the performance measurement does not exceed the performance threshold or the accuracy tuning does not satisfy the accuracy condition.

Example 18 includes the semiconductor apparatus of any one of Examples 13 to 17, wherein to conduct the intra-node tuning, the logic is to determine a compute capacity of the destination edge node, and allocate one or more host processor cores of the destination edge node to the AI workload if the compute capacity does not exceed a capacity threshold.

Example 19 includes the semiconductor apparatus of any one of Examples 13 to 18, wherein the logic coupled to the one or more substrates includes transistor channel regions that are positioned within the one or more substrates.

Example 20 includes a method of operating a performance-enhanced computing apparatus, the method comprising detecting a transfer condition with respect to an artificial intelligence (AI) workload that is active on a source edge node, conducting intra-node tuning on a destination edge node in response to the transfer condition, and moving the AI workload to the destination edge node after the intra-node tuning is complete.

Example 21 includes the method of Example 20, further including conducting accuracy tuning on the destination edge node, and conducting a performance measurement based on the intra-node tuning and the accuracy tuning, wherein the AI workload is moved to the destination edge node if the performance measurement exceeds a performance threshold and the accuracy tuning satisfies an accuracy condition.

Example 22 includes the method of Example 21, wherein the intra-node tuning, the accuracy tuning and the performance measurement are conducted while the AI workload is active on the source edge node.

Example 23 includes the method of Example 21, wherein conducting the accuracy tuning includes calibrating the AI workload based on the intra-node tuning and a validation dataset.

Example 24 includes the method of any one of Examples 21 to 23, further including repeating the intra-node tuning if the performance measurement does not exceed the performance threshold or the accuracy tuning does not satisfy the accuracy condition.

Example 25 includes means for performing the method of any one of Examples 21 to 23.

Technology described herein therefore avoids performance drops when the destination node has a lower compute capacity than the source node. The technology also eliminates accuracy variations when the destination node supports a different precision than the source node. Additionally, the technology avoids temporary disruptions and/or latencies in workload execution (e.g., loss of frames or slower execution) during workload transfers.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing apparatus comprising:
a source edge node;
a destination edge node;
a processor; and
a memory coupled to the processor, the memory comprising a set of instructions, which when executed by the processor, cause the processor to:
detect a transfer condition with respect to an artificial intelligence (AI) workload that is active on the source edge node,
conduct intra-node tuning on the destination edge node in response to the transfer condition, and
move the AI workload to the destination edge node after the intra-node tuning is complete.

2. The computing apparatus of claim 1, wherein the instructions, when executed, further cause the processor to:
conduct accuracy tuning on the destination edge node, and
conduct a performance measurement based on the intra-node tuning and the accuracy tuning, wherein the AI workload is moved to the destination edge node if the performance measurement exceeds a performance threshold and the accuracy tuning satisfies an accuracy condition.

3. The computing apparatus of claim 2, wherein the intra-node tuning, the accuracy tuning and the performance measurement are conducted while the AI workload is active on the source edge node.

4. The computing apparatus of claim 2, wherein to conduct the accuracy tuning, the instructions, when executed, cause the processor to calibrate the AI workload based on the intra-node tuning and a validation dataset.

5. The computing apparatus of claim 2, wherein the instructions, when executed, further cause the processor to repeat the intra-node tuning if the performance measurement does not exceed the performance threshold or the accuracy tuning does not satisfy the accuracy condition.

6. The computing apparatus of claim 1, wherein to conduct the intra-node tuning, the instructions, when executed, cause the processor to:
determine a compute capacity of the destination edge node, and
allocate one or more host processor cores of the destination edge node to the AI workload if the compute capacity does not exceed a capacity threshold.

7. At least one computer readable storage medium comprising a set of instructions, which when executed by a computing system, cause the computing system to:
detect a transfer condition with respect to an artificial intelligence (AI) workload that is active on a source edge node;
conduct intra-node tuning on a destination edge node in response to the transfer condition; and
move the AI workload to the destination edge node after the intra-node tuning is complete.

8. The at least one computer readable storage medium of claim 7, wherein the instructions, when executed, further cause the computing system to:
conduct accuracy tuning on the destination edge node; and
conduct a performance measurement based on the intra-node tuning and the accuracy tuning, wherein the AI workload is moved to the destination edge node if the performance measurement exceeds a performance threshold and the accuracy tuning satisfies an accuracy condition.

9. The at least one computer readable storage medium of claim 8, wherein the intra-node tuning, the accuracy tuning and the performance measurement are conducted while the AI workload is active on the source edge node.

10. The at least one computer readable storage medium of claim 8, wherein to conduct the accuracy tuning, the instructions, when executed, cause the computing system to calibrate the AI workload based on the intra-node tuning and a validation dataset.

11. The at least one computer readable storage medium of claim 8, wherein the instructions, when executed, further cause the computing system to repeat the intra-node tuning if the performance measurement does not exceed the performance threshold or the accuracy tuning does not satisfy the accuracy condition.

12. The at least one computer readable storage medium of claim 7, wherein to conduct the intra-node tuning, the instructions, when executed, cause the computing system to:
determine a compute capacity of the destination edge node; and
allocate one or more host processor cores of the destination edge node to the AI workload if the compute capacity does not exceed a capacity threshold.

13. A semiconductor apparatus comprising:
one or more substrates; and
logic coupled to the one or more substrates, wherein the logic is implemented at least partly in one or more of configurable or fixed-functionality hardware, the logic to:
detect a transfer condition with respect to an artificial intelligence (AI) workload that is active on a source edge node;
conduct intra-node tuning on a destination edge node in response to the transfer condition; and
move the AI workload to the destination edge node after the intra-node tuning is complete.

14. The semiconductor apparatus of claim 13, wherein the logic coupled is to:
conduct accuracy tuning on the destination edge node; and
conduct a performance measurement based on the intra-node tuning and the accuracy tuning, wherein the AI workload is moved to the destination edge node if the performance measurement exceeds a performance threshold and the accuracy tuning satisfies an accuracy condition.

15. The semiconductor apparatus of claim 14, wherein the intra-node tuning, the accuracy tuning and the performance measurement are conducted while the AI workload is active on the source edge node.

16. The semiconductor apparatus of claim 14, wherein to conduct the accuracy tuning, the logic is to calibrate the AI workload based on the intra-node tuning and a validation dataset.

17. The semiconductor apparatus of claim 14, wherein the logic is to repeat the intra-node tuning if the performance measurement does not exceed the performance threshold or the accuracy tuning does not satisfy the accuracy condition.

18. The semiconductor apparatus of claim 13, wherein to conduct the intra-node tuning, the logic is to:
determine a compute capacity of the destination edge node; and
allocate one or more host processor cores of the destination edge node to the AI workload if the compute capacity does not exceed a capacity threshold.

19. The semiconductor apparatus of claim 13, wherein the logic coupled to the one or more substrates includes transistor channel regions that are positioned within the one or more substrates.

20. A method comprising:
detecting a transfer condition with respect to an artificial intelligence (AI) workload that is active on a source edge node;
conducting intra-node tuning on a destination edge node in response to the transfer condition; and
moving the AI workload to the destination edge node after the intra-node tuning is complete.

21. The method of claim 20, further including:
conducting accuracy tuning on the destination edge node; and
conducting a performance measurement based on the intra-node tuning and the accuracy tuning, wherein the AI workload is moved to the destination edge node if the performance measurement exceeds a performance threshold and the accuracy tuning satisfies an accuracy condition.

22. The method of claim 21, wherein the intra-node tuning, the accuracy tuning and the performance measurement are conducted while the AI workload is active on the source edge node.

23. The method of claim 21, wherein conducting the accuracy tuning includes calibrating the AI workload based on the intra-node tuning and a validation dataset.

24. The method of claim 21, further including repeating the intra-node tuning if the performance measurement does not exceed the performance threshold or the accuracy tuning does not satisfy the accuracy condition.

25. The method of claim 20, wherein conducting the intra-node tuning includes:
determining a compute capacity of the destination edge node; and
allocating one or more host processor cores of the destination edge node to the AI workload if the compute capacity does not exceed a capacity threshold.
